(19) United States
(12) Patent Application Publication
(10) Pub. No.: US 2006/0153218 A1
(43) Pub. Date: Jul. 13, 2006

(54) Channel assignment method for optical burst switching (OBS) network

(75) Inventor: Vladimir Shakhov, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-st (KR)

(21) Appl. No.: 11/329,059

(22) Filed: Jan. 11, 2006

(30) Foreign Application Priority Data
Jan. 11, 2005 (KR) 10-2005-0002497

(51) Int. Cl. H04L 12/28

(52) U.S. Cl. 370/431

(57) ABSTRACT

A method for efficiently allocating incoming burst data to output channels over an optical burst switching network when the number of incoming channels is greater than the number of outgoing channels. To this end, BD transferred on at least two incoming channels are grouped to BDs that do not block each other. BDs in a group are allocated to and transmitted on one outgoing channel. BDs in the group not assigned to the output channel are repeatedly delayed, discover time slots in which BDs in the group assigned to the output channel are not transferred, and use the discovered time slots for the transmission.

### CROSS-REFERENCE TO RELATED APPLICATIONS

This application claims priority from Korean Patent Application No. 2005-02497 filed on Jan. 11, 2005 in the Korean Intellectual Property Office, the entire disclosure of which is incorporated herein by reference.

### BACKGROUND OF THE INVENTION

1. Field of the Invention

Methods and systems consistent with the present invention relate in general to optical burst switching (OBS) networks, and more specifically to reducing transmission error of burst data in an OBS network.

2. Description of the Related Art

Primarily, transmission and reception of optical signals through an optical fiber (link) uses an electrical switch. The electrical switch needs to convert an optical signal to an electrical signal and vice versa to process the received optical signal. A network adopting the electrical switch additionally requires an optical-to-electrical converter for converting the optical signal to the electrical signal and an electrical-to-optical converter for converting the electrical signal to the optical signal, which increases costs of the network.

In this regard, an optical burst switch has been suggested, which is capable of directly processing the received optical signal without the conversion to the electrical signal. Hereafter, an optical burst switching (OBS) network using the optical burst switch is described.

Generally, Internet protocol (IP) packets incoming to an optical domain are aggregated to burst data at an edge node in the OBS network. The burst data are routed to their destination node via a core node according to their destinations or quality of service (QoS). A burst control packet (BCP) and burst data (BD) are separated by an offset time and transmitted on different channels. Specifically, the BCP is transmitted prior to the BD by the offset time to reserve a path for the BD in advance. Hence, the BD can be delivered swiftly over the optical network without buffering. The following is an explanation of the transmission of the optical data in reference to FIG. 1.

FIG. 1 depicts nodes that transmit and receive, or switch the BDs over an OBS network. Descriptions are provided on the transmission of the BDs over the OBS network.

As for incoming Internet Protocol (IP) packets, the node A 100, which is an edge node, generates burst data by aggregating the IP packets. Edge nodes 100, 106, and 108 serve to generate and transmit optical burst data packets by aggregating IP packets, or receive the optical burst data packets and divide them into IP packets. Core nodes 102 and 104 are responsible for optically switching the optical burst data. Upon generating the burst data in a desired size, the node A 100 generates and transmits a BCP to the node B 102 being the core node. After the offset time, the node A 100 transmits the burst data to the node B 102. The BCP contains information relating to a destination address and a source address of the burst data, a size of the burst data, QoS, and the offset time.

The node B 102 examines the destination address of the burst data to be received based on the received BCP, determines an optical path, and reserves an optical switching time. While the BCP is converted optic-electronically or electro-optically at the node B 102, the burst data follows the optical path only by the optical switching, without the optic-electronic conversion. The node B 102 can optically switch the burst data to the node D 106 or the node C 104 depending on whether the destination of the burst data provided from the node A 100 is either the node D 106 or the node E 108.

It has been described that the node B 102 relays the burst data from the node A 100 to either the node D 106 or the node E 108. Meanwhile, the node B 102 may be the destination of the burst data originated from the node A 100 or generate burst data to be transmitted to the node D 106 or the node E 108. In other words, the node A 100 being the core node can function as the edge node.

The node B 102 may receive from the node A 100 and the node C 104 BDs destined for the node D 106. In this situation, the node B 102 selects one of the BDs and transfers the selected BD prior to the other, as all of the received BDs cannot be forwarded to the node D 106 at a time. The remaining BDs are delayed for a preset time and then transmitted, to thus avoid the loss of the BDs.

FIG. 2 illustrates a related art method for a preprocessor to prevent the loss of the received BDs when the BDs are received through two input links.

Referring to FIG. 2, a node receives the BDs from two nodes. In detail, a plurality of BDs is received through a first input link and a second input link, respectively. The plurality of the BDs has their inherent wavelengths. As shown in FIG. 2, the wavelength of the BDs is one of λ1 through λm. For instance, let the wavelength of the BD incoming through the first input link be λ1 and a link for outputting the BD be a first output link. Let the wavelength of the BD incoming through the second input link be λ1 and a link for outputting the BD be the first output link. Herein, the wavelength is equivalent to the channel.

An optical switch as a node cannot provide the BDs received through the first input link and the second input link to the first output link at the same time, but provides only one BD to the first output link. The remaining BD is delayed for a preset time to be transferred to the optical switch. An operation of a sub optical switch 210 is explained below.

The sub optical switch 210 provides the BD received through the first input link to the optical switch, and the BD received through the second input link to a wavelength combiner 220. The wavelength combiner 220 combines and provides the received BDs to a delay controller 230. The delay controller 230 delays the provided BDs for a preset time and forwards the delayed BDs to a wavelength splitter 240.

The wavelength splitter 240 splits the received BDs according to their wavelengths and provides the split BD to a corresponding one of sub optical switches 210 through 214. Through the repetition of the above procedure, the node can prevent the loss of the received BDs.

FIG. 3 illustrates another related art method for preventing the loss of BDs received through two input links.

Referring to FIG. 3, a wavelength converter receives BDs through three input links. In particular, the wavelength converter receives the BD with the wavelength λ1 from a first input link, the BD with the wavelength λ1 from a second input link, and the BD with the wavelength λ2 from a third input link. Let a destination of the BDs incoming to the wavelength converter be a first output link.

As described, the optical switch can provide the first output link with only one BD among the BDs with the same wavelength at a specific time. Accordingly, the wavelength converter is provided with unoccupied wavelength of the first output link. The wavelength converter converts the wavelength of the BD of the second input link, to the provided wavelength. In FIG. 3, it can be seen that the wavelength converter converts the wavelength of the BD of the second input link, to λ3.

FIG. 4 depicts that BDs incoming on four channels are transferred on two channels in the related art. Referring to FIG. 4, a first channel delivers first BD and second BD, and a second channel delivers fifth BD. A third channel delivers sixth BD, and a fourth channel delivers third BD and fourth BD.

When attempting to transmit the BDs on the first and fourth channels, the BDs on the second and third channels are delivered using voids predefined in the channel. In more detail, the BD incoming on the second channel is delivered using the void of the first channel, and the BD incoming on the third channel is delivered using the void of the fourth channel.

However, as shown in FIG. 4, the fifth BD incoming on the second channel can be delivered using the void of the first channel while it is infeasible to deliver the sixth BD incoming through the third channel using the void of the fourth channel.

As such, it is inefficient to transmit the BD received through the second channel only on the first channel or transmit the BD received through the third channel only on the fourth channel, as illustrated in FIG. 4. Therefore, a novel method is demanded to efficiently transfer the received BD.

### SUMMARY OF THE INVENTION

The present invention has been provided to solve the above-mentioned and other problems and disadvantages occurring in the conventional arrangement, and an aspect of the present invention provides a method for efficiently transferring incoming burst data (BD) when the number of incoming channels is smaller than the number of outgoing channels.

Another aspect of the present invention provides a method for minimizing loss of transferred BDs when the number of incoming channels is smaller than the number of outgoing channels.

To achieve the above aspects and/or features of the present invention, a channel assignment method for an optical burst switching (OBS) network includes grouping burst data (BD) transferred on at least two incoming channels to BDs that do not block each other; and allocating and transferring BDs in a group on one outgoing channel.

### BRIEF DESCRIPTION OF THE DRAWINGS

These and/or other aspects and advantages of the invention will become apparent and more readily appreciated from the following description of exemplary embodiments, taken in conjunction with the accompanying drawing figures of which:

FIG. 1 depicts an optical burst switching (OBS) network constructed with a plurality of nodes;

FIG. 2 illustrates a construction of a preprocessor in the OBS network;

FIG. 3 illustrates a wavelength converter in the OBS network;

FIG. 4 illustrates a problem of the related art;

FIGS. 5A and 5B illustrate how burst data (BD) are allocated to an outgoing channel according to an exemplary embodiment of the present invention;

FIGS. 6A through 6C illustrate how BDs are allocated to an outgoing channel according to an exemplary embodiment of the present invention;

FIG. 7 outlines an operation of allocating BDs to the outgoing channel according to an exemplary embodiment of the present invention;

FIG. 8 depicts an optical switch having (n+1)-ary incoming channels and n-ary outgoing channels;

FIG. 9 is a graph showing effects according to an exemplary embodiment of the present invention;

FIG. 10 is a graph showing effects according to an exemplary embodiment of the present invention;

FIG. 11 is a graph showing effects according to an exemplary embodiment of the present invention; and

FIG. 12 is a graph showing effects according to an exemplary embodiment of the present invention.

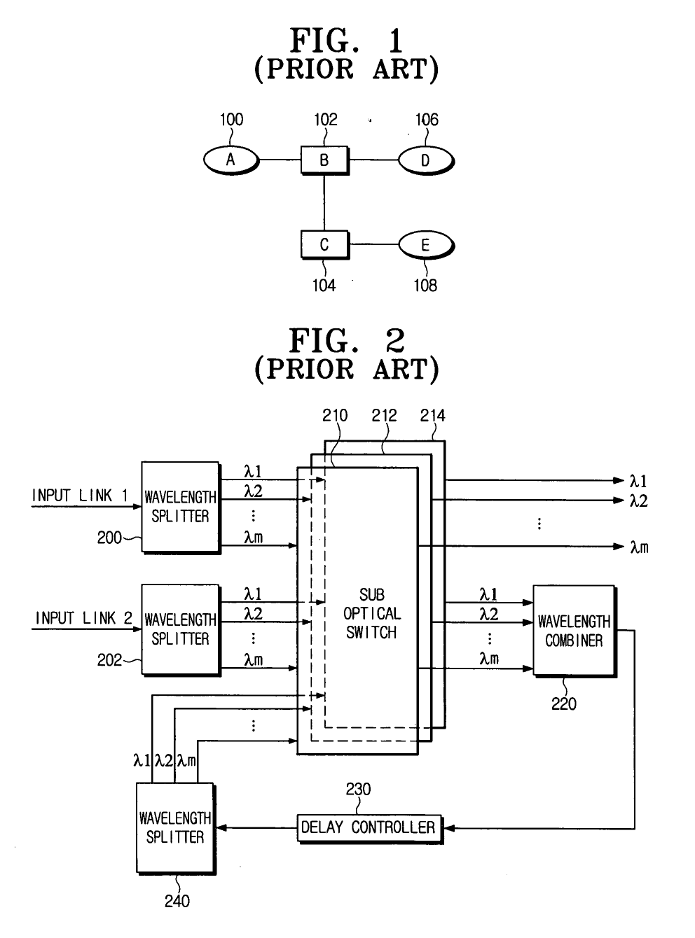

### DETAILED DESCRIPTION OF THE EXEMPLARY EMBODIMENTS

Exemplary embodiments of the present invention will now be described in greater detail with reference to the accompanying drawings.

In the following description, same drawing reference numerals are used for the same elements even in different drawings. The matters defined in the description, such as detailed construction and element descriptions, are provided to assist in a comprehensive understanding of the invention. Also, well-known functions or constructions are not described in detail since they would obscure the invention in unnecessary detail.

Hereinbelow, a method for efficiently transferring burst data (BD) incoming through input links to an output link according to an exemplary embodiment of the present invention is elucidated in reference to the attached drawings.

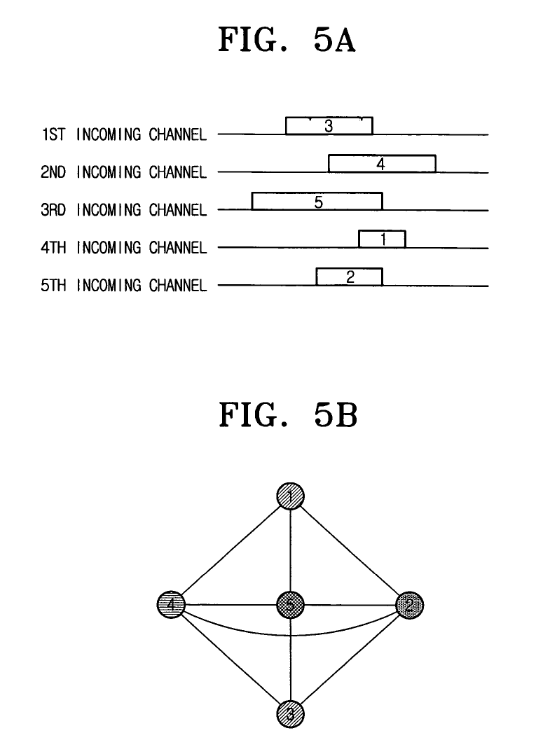

FIGS. 5A and 5B illustrate how to transfer BDs incoming through input links to an output link according to an exemplary embodiment of the present invention. In FIGS. 5A and 5B, a node processes the received BDs by the set, as explained below.

Referring first to FIG. 5A, the set includes third BD on a first channel, fourth BD on a second channel, fifth BD on a third channel, first BD on a fourth channel, and second BD on a fifth channel.

Descriptions are made on the method for efficiently transferring received BDs in reference to FIG. 5B.

In FIG. 5B, circles with numbers represent the received BDs. That is, circles corresponding to the first BD and the fifth BD are drawn. Next, circles corresponding to overlapping BDs are connected to each other. Referring to FIG. 5A and FIG. 5B, the first BD is connected with the second BD, the fourth BD, and the fifth BD. The second BD is connected with the third BD, the fourth BD, and the fifth BD. The third BD is connected with the fourth BD and the fifth BD, and the fourth BD is connected with the fifth BD.

The BDs not connected to each other are delivered on one channel. For example, the first BD and the third BD are transferred on one channel. The second BD, the fourth BD, and the fifth BD are transferred on separate channels.

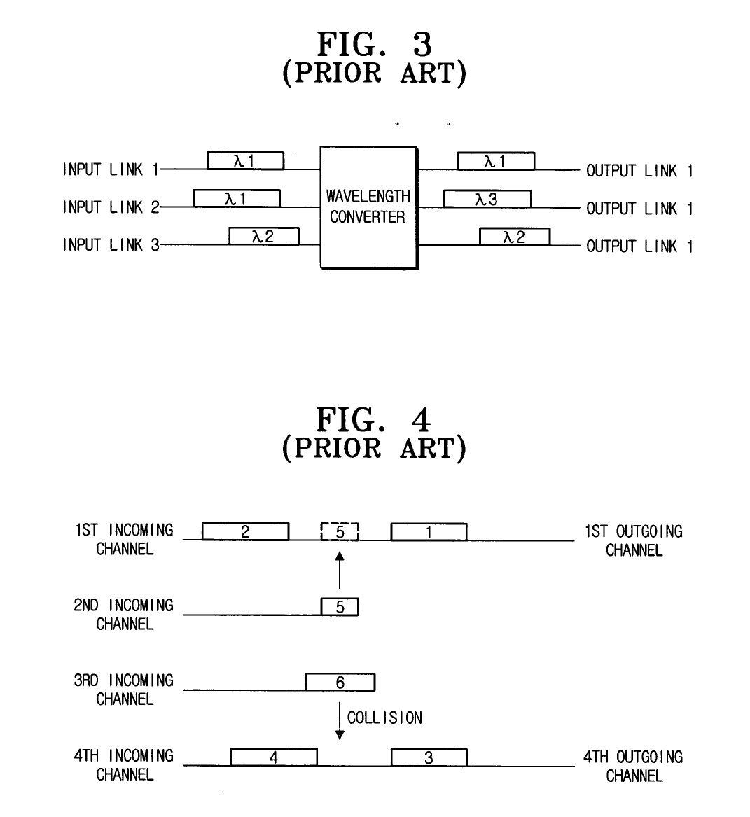

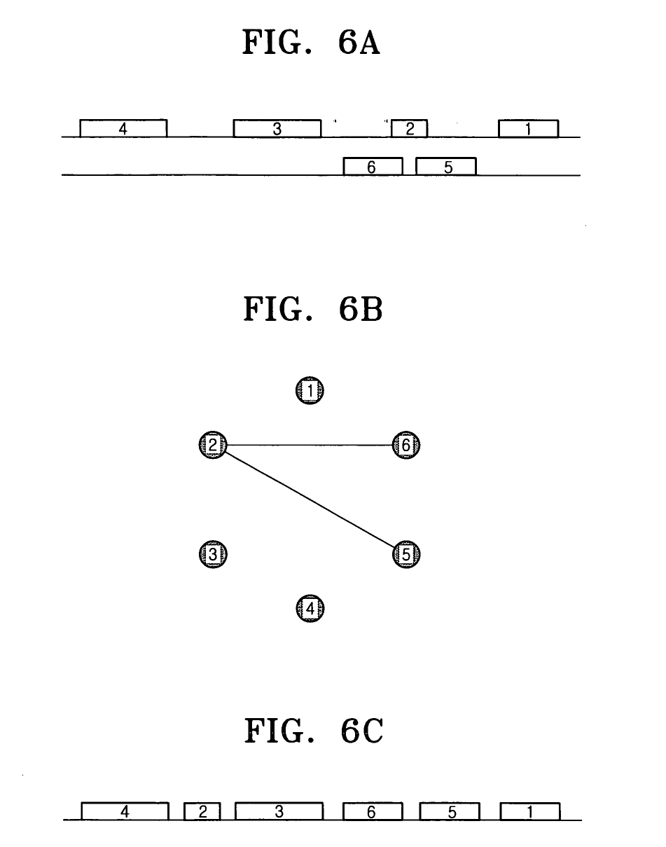

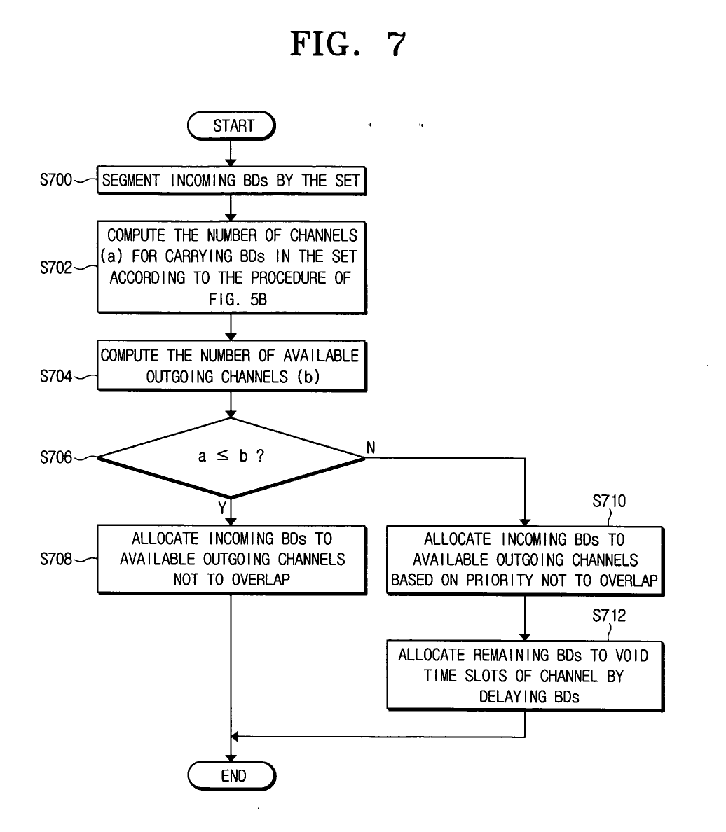

FIGS. 6A through 6C are diagrams illustrating how received BDs are efficiently transferred according to an another exemplary embodiment of the present invention. While the received BD is not delayed but only its wavelength is converted for the transmission as shown in FIGS. 5A and 5B, the method, as shown in FIGS. 6A through 6C, conducts the delay and the wavelength conversion to the received BD as set forth earlier in reference to FIG. 2 and FIG. 3.

In FIG. 6A, a node receives first through fourth BDs on a first channel, and receives fifth and sixth BDs on a second channel. As described, the first through sixth BDs compose one set. The node transfers the received BDs on one channel. It can be seen that the second BD on the first channel collides with the fifth and sixth BDs on the second channel because they are overlapping.

Referring to FIG. 6B, a circle corresponding to the second BD is connected to a circle corresponding to the fifth BD and a circle corresponding to the sixth BD. The BDs represented as isolated circles that are not connected to each other are delivered on one channel. There are two schemes to connect the received BDs not to overlap mutually. According to the first scheme, the first BD, the fifth BD, the sixth BD, the third BD, and the fourth BD are transferred on one channel, and the second BD is transferred on another channel. The second scheme transfers the first BD, the second BD, the third BD, and the fourth BD on one channel, and transfers the fifth BD and the sixth BD on another channel.

At this time, if at least two outgoing channels are given, the BDs are transferred according to either the first scheme or the second scheme. As for only one outgoing channel, the number of the BDs on one channel is considered. Specifically, the first scheme can transfer five BDs on one channel to its maximum, and the second scheme can transfer four BDs on one channel. In effect, the node transmits the BDs according to the first scheme. However, the second BD may be not transferred according to the first scheme. To prevent this, the first scheme inserts the second BD between the third BD and the fourth BD. The second BD is inserted and transmitted between the third BD and the fourth BD by delaying the received second BD over a preset time.

The method for allocating the BDs to the plurality of channels in FIG. 6 is discussed below in reference to FIG. 7.

The node segments incoming BDs by the set (S700). The segmentation of the incoming BDs by the set can be conducted according to a first scheme segmenting incoming BDs into finite number of BDs, a second scheme segmenting BDs by the time unit, and a third scheme segmenting BDs by the unit based on the incoming time of the BD.

The node computes a minimal number of channels ‘a’ for transferring the BDs in the set according to the procedure as illustrated in FIG. 5A and FIG. 5B (S702). The computation does not take the delay of the BD into account. The node computes the number of available outgoing channels ‘b’ (S704). Note that the computation is made to the number of substantial channels capable of carrying the BDs, rather than the number of actual outgoing channels.

The node compares the ‘a’ computed at operation S702 with the ‘b’ computed at operation S704 (S706). According to a result of the comparison, when the ‘b’ is equal to or greater than the ‘a’, the node proceeds to operation S708, and when the ‘b’ is smaller than the ‘a’, the node proceeds to operation S710. The node assigns the received BDs to the available outgoing channels such that the assigned BDs do not overlap with each other (S708). At this time, the isolated BDs that are not connected with each other according to the coloring as shown in FIG. 5B, are assigned to one channel.

The node allocates the incoming BDs to the available outgoing channels based on their priority so that the allocated BDs do not overlap with each other (S710). At this time, the isolated BDs that are not connected with each other according to the coloring as shown in FIG. 5B, are assigned to one channel. Referring back to FIG. 6, the computed ‘a’ is 2 and the computed ‘b’ is 1. The node transfers the BDs according to the first segmentation scheme. In this case, the second BD is subject to the drop without the transmission. The following description provides how the second BD is transferred.

The node allocates the remaining BDs, which are not assigned to the outgoing channels, to void time periods of the outgoing channels by delaying the remaining BDs (S712). To this end, the node requires the construction responsible to delay the BDs, which has been illustrated in FIG. 2. There are two schemes for discovering the void time periods. The first scheme delays the BDs by the unit of a preset time and checks whether the delayed time period is void. The second scheme discovers the void time periods after the BDs are allocated to the outgoing channels at operation S710. The second scheme is preferred to minimize the loss of the BDs.

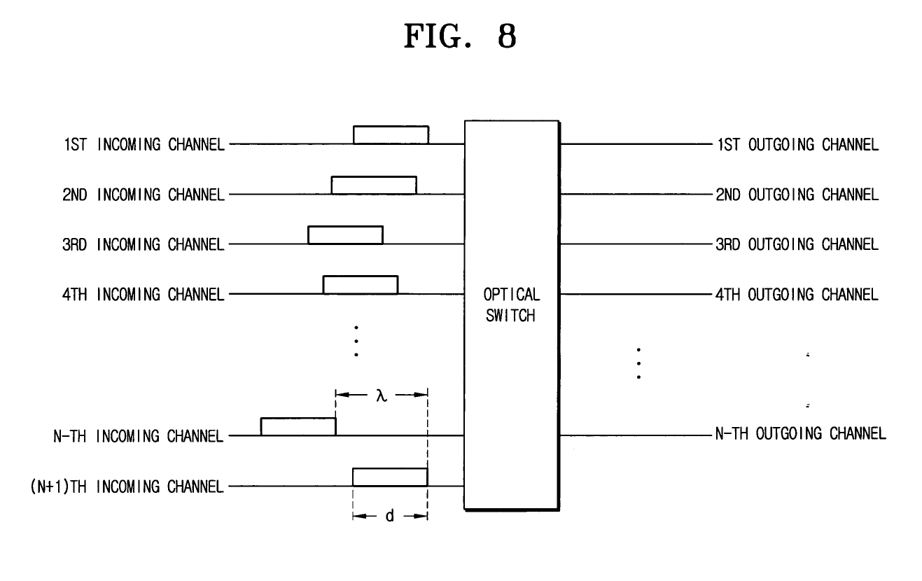

Hereafter, technical effects of the present invention are set forth in reference to FIG. 8 through FIG. 12, in comparison with the related art.

FIG. 8 depicts an optical switch that transfers BDs received on (n+1)-ary incoming channels to n-ary outgoing channels. Especially, the descriptions focus on how to allocate BD provided on the (n+1)th incoming channel to one of the first through n-th outgoing channels. Let the size of the BD on the (n+1)th incoming channel be d, a difference between incoming points of the BDs incoming on the channels be τ, and an average of τ s be a.

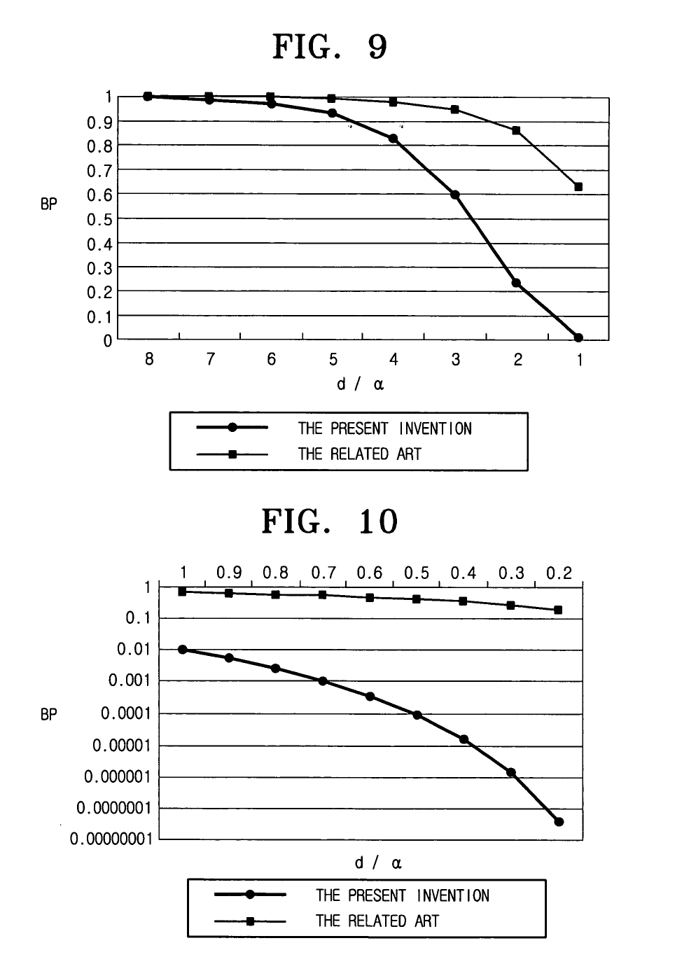

FIG. 9 is a graph showing effects of the present invention, as comparing with the related art that allocates the BD received on the (n+1)th incoming channel to one of the first through n-th outgoing channels. In FIG. 9, the horizontal axis indicates a ratio of d to a, especially, ranging from 1 to 8. The vertical axis indicates a blocking probability (BP) between the BD on the (n+1)th incoming channel and the BDs on the first through n-th incoming channel. It can be seen from FIG. 9 that the present invention reduces the BP as comparing with the related art.

FIG. 10 is another graph showing the effects of the present invention in comparison with the related art. In FIG. 10, the horizontal axis indicates a ratio of d to a, especially, ranging from 0.2 to 1. The vertical axis indicates a BP between the BD on the (n+1)th incoming channel and the BDs on the first through n-th incoming channel. It can be seen from FIG. 10 that the present invention greatly reduces the BP as comparing with the related art.

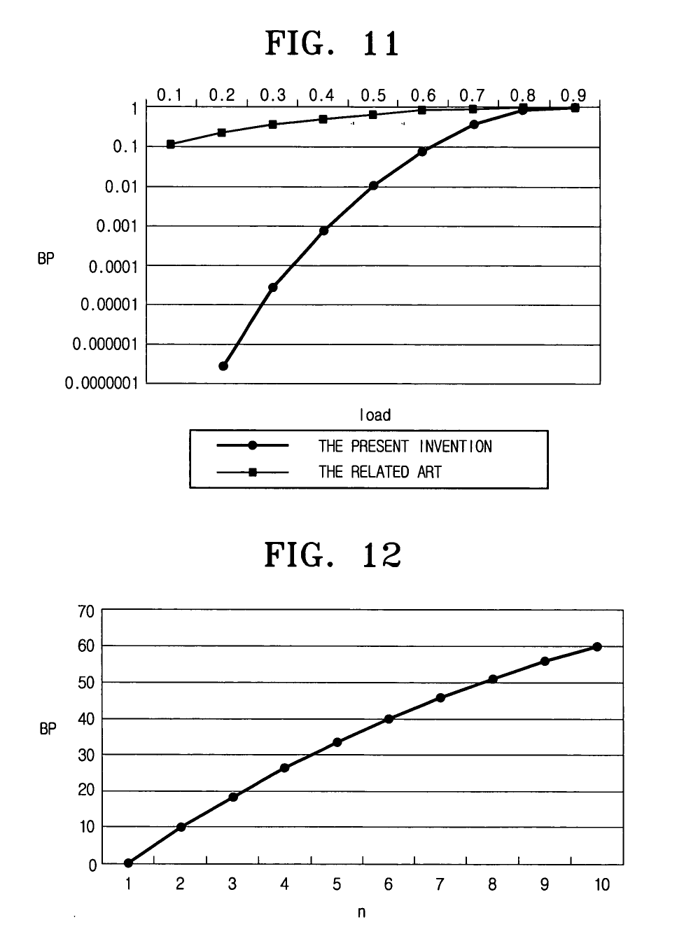

FIG. 11 is yet another graph showing the effects of the present invention in comparison with the related art. In FIG. 11, the horizontal axis indicates a load substantially given with respect to a maximum load on the network, and the vertical axis indicates a BP between the BD on the (n+1)th incoming channel and the BDs on the first through n-th incoming channel. It can be seen from FIG. 11 that the present invention greatly reduces the BP as comparing with the related art.

FIG. 12 is still another graph showing the effects of the present invention. The horizontal axis indicates the number of channels n, and the vertical axis indicates between the BD on the (n+1)th incoming channel and the BDs on the first through n-th incoming channel.

As noted above, the present invention provides the method for efficiently transferring incoming BDs even when the number of incoming channels is smaller than the number of outgoing channels. The wavelength conversion and the data delay are conducted to the incoming BDs, to thus minimize the loss rate of the BDs. Furthermore, as the loss rate of the BDs is reduced, the outgoing channels can be utilized efficiently.

While the present invention has been particularly shown and described with reference to exemplary embodiments thereof, it will be understood by those skilled in the art that various changes in form and details may be made therein without departing from the spirit and scope of the invention as defined by the claims.

What is claimed is:

1. A channel assignment method for an optical burst switching (OBS) network, the method comprising:
grouping burst data (BD) transferred on at least two incoming channels to BDs that do not block each other; and
allocating and transferring the BDs in a group on one outgoing channel.

2. The channel assignment method of claim 1, wherein the grouping of the BDs comprises:
grouping BDs not blocking each other to a first group; and
grouping BDs that do not belong to the first group and do not block each other, to a second group.

3. The channel assignment method of claim 1, wherein a group having a highest number of BDs in comparison to other groups is assigned to the outgoing channel prior to the other groups.

4. The channel assignment method of claim 3, wherein BDs in a group that are not assigned to the outgoing channel are transferred using void time slots of the group assigned to the outgoing channel.

5. The channel assignment method of claim 4, wherein the void time slots are discovered by delaying the BDs in the group not assigned to the outgoing channel, by preset time slots.

6. The channel assignment method of claim 4, wherein the void time slots are discovered by comparing a size of the BD in the group assigned to the outgoing channel with a size of the BDs in the group not assigned to the outgoing channel.

7. The channel assignment method of claim 6, wherein the BDs in the group that are not assigned to the outgoing channel and do not discover the void time slots, are dropped.

8. The channel assignment method of claim 1, wherein the channel is divided based on a wavelength of an optical signal used over the OBS network.

9. The channel assignment method of claim 1, wherein the grouping of the BDs is performed when the number of the BDs transferred on the at least two incoming channels becomes a first set number.

10. The channel assignment method of claim 1, wherein the BDs transferred on the at least two incoming channels are grouped by a first set time.

11. The channel assignment method of claim 1, wherein, when the incoming of the BDs on two incoming channels is interrupted, incoming BDs prior to the interruption are grouped.
